(19) United States
(12) Patent Application Publication
(10) Pub. No.: US 2011/0297518 A1
(43) Pub. Date: Dec. 8, 2011

(54) TRIPPING UNIT FOR CIRCUIT BREAKER

(75) Inventors: Guenter Baujan, Troisdorf (DE); Klaus Dauer, Koblenz (DE); Anke Juelich, Niederkassel (DE)

(73) Assignee: EATON INDUSTRIES GMBH, Bonn (DE)

(21) Appl. No.: 13/153,584

(22) Filed: Jun. 6, 2011

(30) Foreign Application Priority Data
Jun. 8, 2010 (EP) 10165311.1

(51) Int. Cl. H01H 3/54

(52) U.S. Cl. 200/17 R

(57) ABSTRACT

A multipolar circuit breaker includes main circuits having main contacts and a latching mechanism for tripping the main contacts of main circuits. A tripping unit configured to actuate the latching mechanism in response to detection of an over-current in at least one of the main circuits. The tripping unit is plugged into a section of the circuit breaker and includes at least one bimetal strip connected in series with at least one of the main circuits and operatively connected with the latching mechanism.

### CROSS REFERENCE TO RELATED APPLICATIONS

This application claims priority to European Patent Application No. EP 10 165 311.1, filed on Jun. 8, 2010, which is hereby incorporated by reference herein in its entirety.

### FIELD

The invention relates to a tripping unit for tripping the main contacts of main circuits of a multipolar circuit breaker.

### BACKGROUND

Circuit breakers can be configured as motorcircuit breakers or as automatic circuit breakers that are employed to switch a load on and off and that have a protective function by separating or interrupting the load in case of an electrical fault. Electrical faults can be e.g. short circuits or overcurrents. Such circuit breakers comprise essentially a base module, a manual actuating device, a control unit, an actor unit and a tripping element. Through the use of the manual actuating device, at least a switching mechanism is activated by means of a rotary knob and of an actuating shaft, whereby the actuating device is accommodated in a housing part that protrudes from the operating front of the circuit breaker.

As a motor circuit breaker, circuit breakers can have a tripping behavior that is adapted to the electric motor to be protected, or which serve as line circuit breakers to protect electric lines or systems against thermal overload or short-circuit damage. The tripping behavior and thus the use of such circuit breakers are determined by the thermal and short-circuit tripping values. To implement different tripping behavior in a circuit breaker, it is possible to build up a modular circuit breaker which includes a replaceable tripping module.

The German patent application DE 36 42 719 A1 describes a manually operated protective circuit breaker which comprises a plug-in exchangeable overcurrent tripping unit.

Multipole circuit breakers can be adapted to control and switch main circuits under AC conditions. All main circuits are under voltage. Therefore it is useful to have tripping means which controls every main circuit so that in case an over-current in one of the mains circuit is given, the circuit breaker can switch off all main circuits. In a DC environment normally one main circuit is under voltage. Using a multipole circuit breaker in a DC environment means that all unused poles are bridged such that all switches are connected in series or just one pole is used while the other poles are left open. Using a multipole circuit breaker including multipole tripping means is not cost efficient, because in a DC environment, several tripping means are installed but are not used.

### SUMMARY

In an embodiment, the present invention provides a multipolar circuit breaker including main circuits having main contacts and a latching mechanism for tripping the main contacts of main circuits. A tripping unit configured to actuate the latching mechanism in response to detection of an over-current in at least one of the main circuits. The tripping unit is plugged into a section of the circuit breaker and includes at least one bimetal strip connected in series with at least one of the main circuits and operatively connected with the latching mechanism.

### BRIEF DESCRIPTION OF THE DRAWINGS

Exemplary embodiments of the present invention are described in more detail below with reference to the drawings, in which:

FIG. 1 shows a 3-D view of multipole circuit breaker including a plugged tripping unit;

FIG. 2 shows a 3-D view of the multipole circuit breaker of FIG. 1 without the housing of the tripping unit with one bimetal strip;

FIG. 3 shows a 3-D view of the multipole circuit breaker of FIG. 1 without the housing of the tripping unit with a bimetal strip for each pole of the circuit breaker,

FIG. 4 shows a 3-D view of a tripping unit comprising one bimetal strip;

FIG. 5 shows a 3-D view of a tripping unit comprising three bimetal strips;

FIG. 6 shows a 3-D view of a latching mechanism of the circuit breaker;

FIG. 7 shows a 3-D view of the latching mechanism of FIG. 6 from another side;

FIG. 8 shows a 3-D view of parts of the latching mechanism of FIG. 6;

FIG. 9 shows a 3-D view of parts of the latching mechanism of FIG. 6.

### DETAILED DESCRIPTION

An aspect of the present invention is to overcome the drawbacks set forth above. In an embodiment the present invention provides at tripping unit for tripping the main contacts of main circuits of a multipolar circuit breaker by mechanically actuating a latching mechanism in the circuit breaker when an over-current in at least one of the main circuits is detected. This embodiment is characterized in that the tripping unit is pluggable into the circuit breaker and includes at least one bimetal strip which is connected in series to a main circuit of the circuit breaker and wherein the bimetal strip is operatively connected with the latching mechanism. It is easy to replace the tripping unit by another tripping unit with different parameters. The circuit breaker can be easily adapted to a AC or DC environment by just replacing the tripping unit.

In another embodiment, the tripping unit comprises one bimetal strip which is allocated to one main circuit and wherein the tripping unit further comprising bridge circuits which are connected in series to all the remaining main circuits of the circuit breaker. With this setup, the circuit breaker is usable in a DC environment which normally comprises one main circuit within which the current flows. The other poles in the multipole circuit breaker are connected in series to the main pole through which the current flows. Therefore only one bimetal strip is necessary to detect over-current and to mechanically trip the latching mechanism of the circuit breaker to switch off the main contacts.

In another embodiment the tripping unit comprises a bimetal strip for each main circuit of the circuit breaker wherein each bimetal strip is connected in series to one of the main circuits of the circuit breaker. In an AC environment, every pole of the circuit breaker (normally 3 poles) is under voltage. It is therefore advantageous to detect over-current in every main circuit. A tripping unit with bimetal strips in every pole is needed. The tripping units easily be replaced to fulfill the security conditions in each environment (AC or DC).

In another embodiment the tripping unit further comprises a housing with a receiving area for receiving the at least one bimetal strip and a cover plate which is moveably arranged at the housing. Advantageously, the at least one bimetal strip is pluggable in the receiving area of the tripping unit. In this embodiment it is easy to assemble the tripping unit automatically or to replace a broken bimetal strip.

In another embodiment the at least one bimetal strip is wrapped by a heater through which the current of the main circuits of the circuit breaker is flown. The bimetal strip reacts faster based on heat which results from the over-current.

In another embodiment the tripping unit comprises a bimetal bridge which is operatively connected to the at least one bimetal strip such that it is moved when at least one bimetal strip is deformed by the heat of an over-current in at least one of the main circuits of the circuit breaker. All bimetal strips are connected to this bimetal bridge such that if any one of the bimetal strips is deformed in case of an over-current, the bimetal bridge is operative connected to the latch mechanism of the circuit breaker. In another embodiment of the invention, the bimetal bridge (31) is operatively connected to a lever (32) inside the tripping unit (2) which trips the latching mechanism (14) of the circuit breaker (1) when the bimetal bridge (31) is moved.

The invention is further related to a circuit breaker comprising a tripping unit according to any of the embodiments described above.

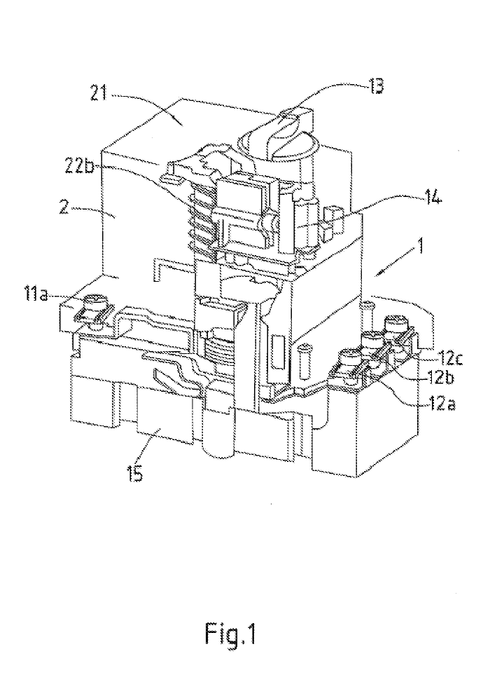

FIG. 1 depicts a 3-pole circuit breaker 1 including a switching area 15 in which the main switches of the main circuits are located. Over first terminals 11a, 11b, 11c and second terminals 12a, 12b, 12c, the circuit breaker 1 is connected to an electric network and to an electric user, e.g. a motor. The main switches are operatively connected to a latching mechanism 14. This latching mechanism 14 provides input means which trip the latching mechanism 14 to switch off the main switches of the circuit breaker 1. One input means is a knob 13 which is located outside the circuit breaker 1. It is possible to manually switch on or off the mains switches of the circuit breaker 1. The circuit breaker 1 further comprises a tripping unit 2 which is pluggably connected to the circuit breaker 1. Therefore it is possible to take off the tripping unit 2 and to replace it by another one. It is understood that the invention relates also to circuit breakers 1 with more or less than three poles or mains circuits.

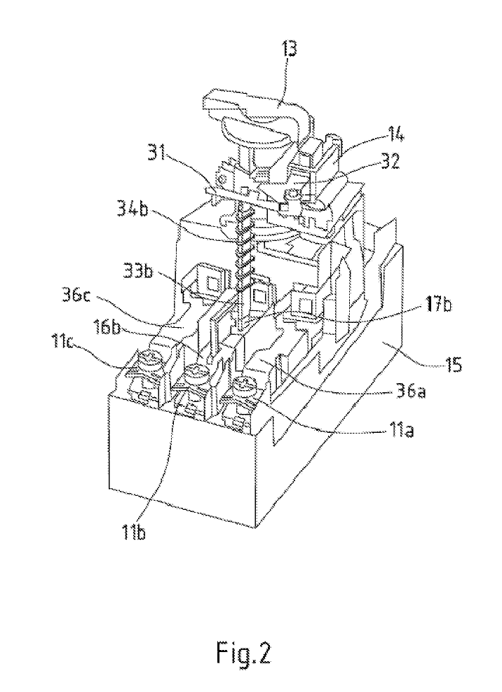

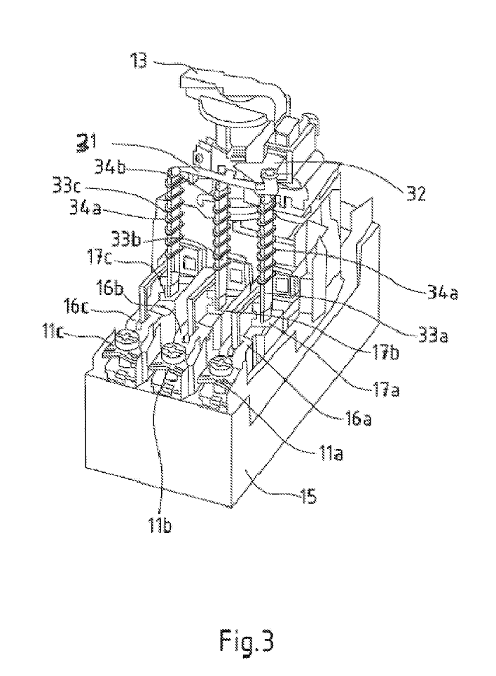

FIGS. 2 and 3 depict the circuit breaker 1 without the housing 21 of the tripping unit 2. FIG. 2 shows a circuit breaker 1 with a bimetal strip 33b which is connected in series to the central main circuit. The other main circuits are connected in series to bridge units 36a, 36c, which bridges the terminals 11a, 11b, 11 c with the contact points of the main switches. This embodiment is used in a DC environment, wherein only one main circuit is under voltage. The other main circuits of the circuit breaker 1 can be connected in series such that only one main circuit, including three main switches and one bimetal strip 33b, is available. The bimetal strip 33b is part of the tripping unit 2 and is plugged into a bimetal socket 17b. A heater 34b is wrapped around the bimetal strip 33b such that the current flows through the heater 34b and afterwards through the bimetal strip 33b or vice versa. Therefore an isolated material is provided between the bimetal strip 33b and the heater 34b so that no short circuit can occurs. The heater 34b comprises a heater bridge 35b which connects the heater 34b to the heater socket 16b located in the circuit breaker 1. The current flows from the first terminal 11b through the heater socket 16b over the heater bridge 35b into the heater and afterwards through the bimetal strip 33b over the bimetal socket 17b through the main switch and the second terminal 12b.

The bimetal strip 33b is operatively connected to a bimetal bridge 31 such that when the bimetal strip 33b is deformed by the heat of an over-current which flows through the heater 34b and the bimetal strip 33b, the agitation of the bimetal strip 33b is transferred to a move of the bimetal bridge 31. The bimetal strip 31 is operative connected to a lever 32 which trips the latching mechanism 14 of the circuit breaker 1. The bimetal strip 31 and the lever 32 are parts of the tripping unit 2 and are located inside the housing 21 of the tripping unit 2. Only one part of the lever 32 pokes out of the housing 21 to be operatively connected to the latching mechanism 14.

FIG. 3 shows a circuit breaker 1 with a tripping unit 2 comprising three bimetal strips 33a, 33b, 33c. In this embodiment, all main circuits are connected in series with the bimetal strips 33a, 33b, 33c of the tripping unit 2. All three bimetal strips 33a, 33b, 33c are wrapped with heaters 34a, 34b, 34c, whereas the heaters 34a, 34b, 34c comprise heater bridges 35a, 35b, 35c which are plugged into the heater sockets 16a, 16b, 16c of the circuit breaker 1. The bimetal strips 33a, 33b, 33c are plugged into bimetal sockets 17a, 17b, 17c of the circuit breaker 1. The bimetal bridge 31 is operatively connected to all bimetal strips 33a, 33b, 33c such that if an over-current in any of the bimetal strips 33a, 33b, 33c occurs, the bimetal bridge 31 is moved and transfers the agitation over a lever 32 to the latching mechanism 14 which opens all main contacts of the circuit breaker 1.

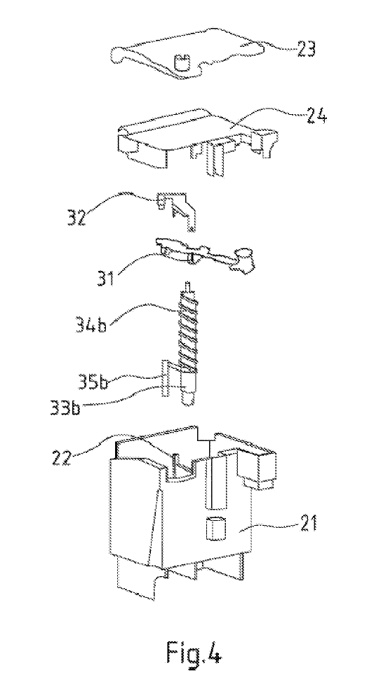

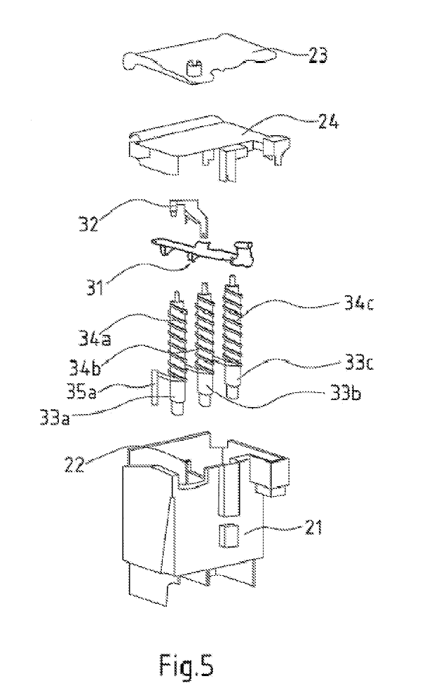

FIG. 4 and FIG. 5 depict an exploded-view drawing of a tripping unit 2, comprising a housing 21 with a receiving area 22 for at least one bimetal strip 33a, 33b, 33c whereas the bimetal strips 33a, 33b, 33c are wrapped with a heater 34a, 34b, 34c. The heater bridge 35a, 35b, 35c and the bimetal strips 33a, 33b, 33c penetrates the bottom part of the housing 21 such that they can be plugged into the heater- and bimetal-sockets 16a, 16b, 16c, 17a, 17b, 17c of the circuit breaker 1. A bimetal bridge 31 and a lever 32 are also operative connected to the bimetal strip 33a, 33b, 33c. A cover plate 24 is articulated to the housing 21 such that it is possible to open and close the tripping unit 2 by moving the cover plate 24. A further shutter 23 can be articulated to the cover plate 24. It is possible to replace a bimetal strip 33a, 33b, 33c with a bridge circuit 36a, 36c.

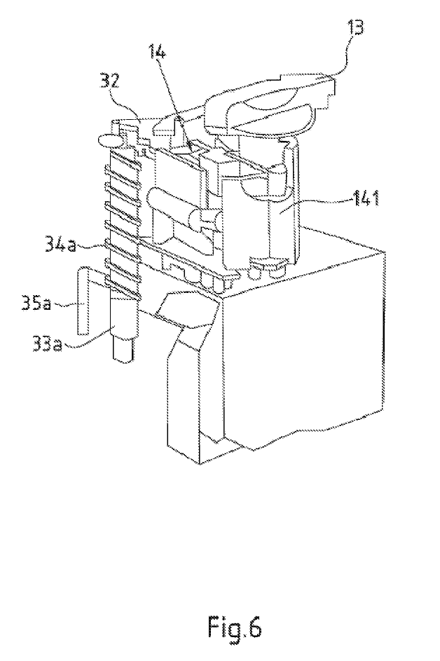

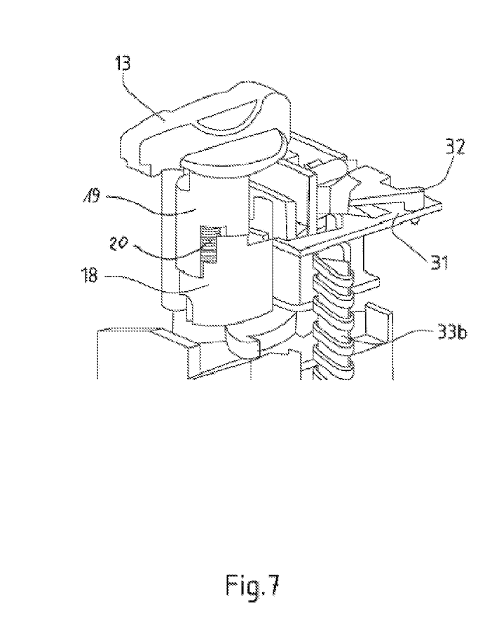

FIG. 6 and FIG. 7 depict a latching mechanism 14 of a circuit breaker 1 with a knob 13 for manually tripping the latching mechanism 14. As part of the tripping unit 2, a bimetal strip 33a, 33b is shown which is operatively connected via a bimetal bridge 31 and a lever 32 to the latching mechanism 14. FIG. 7 shows a knob 13 with a pre-stress unit 19 and a pull protection 18 below the knob 13. With the knob 13, the pre-stress unit 19 pre-stresses a spring 20 enclosed by the pre-stress unit 19 and the pull protection 18 of about an angle of 20 degree to tension the angle bracket 141 and subsequently the spring 143. During tripping, the pre-stress unit remains in its position. The pull protection 18 is movably connected to the latching mechanism 14 such that if the circuit breaker 1 is closed (contacts are closed), it is not possible to take off the tripping unit 2 from the circuit breaker 1. Therefore the pull protection 18 blocks the tripping unit 2 by moving protrusions into the housing 21 of the tripping unit 2.

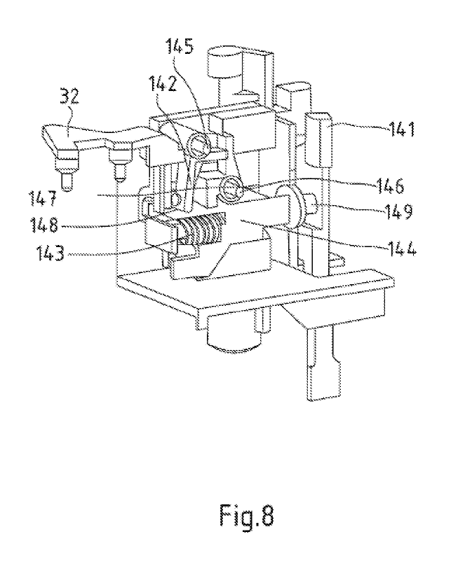

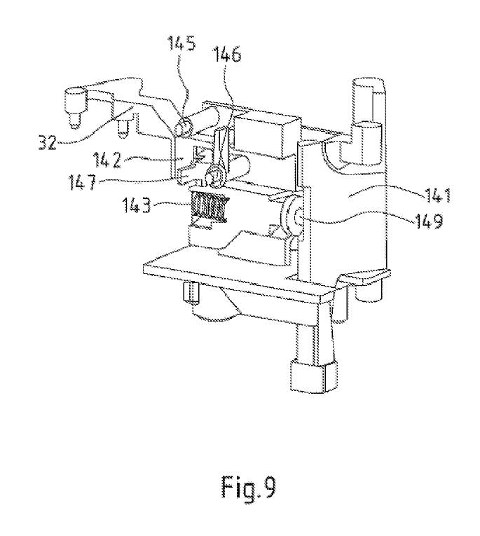

FIGS. 8 and 9 depict a part of the latching mechanism 14 in different views. The lever 32, which is operatively connected to the bimetal bridge 31, is connected to a latch plate 142 which is hinged to a first shaft 145 in order to expand the strained spring 143 via the latch plate 142 for tripping the main contacts of the main circuits. The latch plate 142 is operatively connected to a rack element 147 which is hinged to a second shaft 146. A strained spring 143 is deployed inside a springholder 144 such that the rack element 147 prevents the strained spring 143 from expanding. Therefore the springholder 144 comprises a hook 148 which is operative connected to the rack element 147. The spring 143 is operative connected to a push rod 149 which is adapted to actuate against an angel bracket 141. The angel bracket 141 is connected to a shaft which switches the main contacts of the circuit breaker 1.

If the lever is moved due to an over-current in one of the bimetal strips 33a, 33b, 33c, the rack element 147 moves and releases the hook 148 at the springholder 144. The spring 143 expands and pushes the push rod 149 against the angel bracket 141. The main contacts of the circuit breaker 1 switch off.

While the invention has been particularly shown and described with reference to preferred embodiments thereof, it will be understood by those skilled in the art that various changes in form and details may be made therein without departing from the spirit and scope of the invention.

### REFERENCE NUMERALS

1 circuit breaker
11a, 11b, 11c terminal
12a, 12b, 12c terminal
13 knob
14 latching mechanism
141 angle bracket
142 latch plate
143 spring
144 spring holder
145 shaft
146 shaft
147 rack element
148 hook
149 push rod
15 switching area
16a, 16b, 16c heater socket
17a, 17b, 17c bimetal socket
18 pull protection
19 pre-stress unit
20 spring
2 tripping unit
21 housing
22 receiving area
23 shutter
24 cover plate
31 bimetal bridge
32 lever
33a, 33b, 33c bimetal strip
34a, 34b, 34c heater
35a, 35b, 35c heater bridge
36a, 36c bridge circuit

What is claimed is:

1. A multipolar circuit breaker comprising:
main circuits including main contacts;
a latching mechanism configure to trip the main contacts; and
a tripping unit configured to actuate the latching mechanism in response to detection of an over-current in at least one of the main circuits, the tripping unit being plugged into a section of the circuit breaker, the tripping unit including at least one bimetal strip connected in series with at least one of the main circuits and operatively connected with the latching mechanism.

2. The circuit breaker recited in claim 1, wherein the at least one bimetal strip includes a first bimetal strip corresponding to a first of the main circuits, and further comprising bridge circuits connected in series to a remainder of the main circuits.

3. The circuit breaker recited in claim 1, wherein the at least one bimetal strip includes a plurality of bimetal strips, each corresponding to a respective main circuit of the main circuits, each bimetal strip connected in series to the respective main circuit of the circuit breaker.

4. The circuit breaker recited in claim 1, wherein the tripping unit includes a housing having a receiving area for the at least one bimetal strip and a cover plate movably disposed on the housing.

5. The circuit breaker recited in claim 4, wherein the at least one bimetal strip is plugged into the receiving area.

6. The circuit breaker recited in claim 1, wherein the tripping unit includes a heater wrapped around the at least one bimetal strip and configured to receive a current of the main circuits.

7. The circuit breaker recited in claim 1, wherein the tripping unit includes a bimetal bridge operatively connected to the at least one bimetal strip so as to move in accordance with a deforming of the at least one bimetal strip resulting from an over-current in at least one of the main circuits.

8. The circuit breaker recited in claim 7, wherein the bimetal bridge is operatively connected to a lever inside the tripping unit, the lever being configured to trip the latching mechanism in response to the movement of the bimetal bridge.
